(19) United States
(12) Patent Application Publication
(10) Pub. No.: US 2011/0161322 A1
(43) Pub. Date: Jun. 30, 2011

(54) IMAGE FORMING APPARATUS, INFORMATION PROCESSING APPARATUS, DATA PROCESSING SERVER, AND INFORMATION PROCESSING METHOD

(75) Inventor: Nobuyuki Shigeeda, Kawasaki-shi (JP)

(73) Assignee: CANON KABUSHIKI KAISHA, Tokyo (JP)

(21) Appl. No.: 12/971,439

(22) Filed: Dec. 17, 2010

(30) Foreign Application Priority Data
Dec. 28, 2009 (JP) 2009-298808

(51) Int. Cl. G06F 17/30

(52) U.S. Cl. 707/736; 707/E17.044

(57) ABSTRACT

An image forming apparatus includes a reading unit configured to read watermark information including information for search from an electronic document, and a pre-processing unit configured to execute a process for extracting feature amount or text information as information for search from the electronic document if the reading unit does not read the watermark information including information for search, and to skip the process for extracting feature amount or text information if the reading unit reads the watermark information including information for search.

### BACKGROUND OF THE INVENTION

1. Field of the Invention

The present invention generally relates to image forming and, more particularly, to an image forming apparatus, an information processing apparatus, a data processing server, and an information processing method.

2. Description of the Related Art

There is an image history inspection system in which a job history and a content (image information and text information) history (hereinafter referred to as “content history”) in an image forming apparatus and a user PC are collected, stored and managed in a database, and reference is made to the contents later. Using the image history inspection system allows an administrator to inspect later when, where, what, how, and by whom processes (copy, facsimile, print, scan, and sending, hereinafter referred to as “job”) are performed. This allows preventing confidential information handling in an office from being leaked via a device.

The administrator searches a job history and a content history at the time of inspection and finds out a doubtful job of which information may be leaked, from a large amount of history information. The image history inspection system can also search image information and text information.

In order to perform a search using an image (hereinafter referred to as “image search”), the image history inspection system extracts feature amount from an image related to a job and registers the feature amount in a database along with a history. The image history inspection system registers a text acquired by an optical character recognition (OCR) process from the image related to the job in the database to realize a search using the text (hereinafter referred to as “full-text search”). The extracting process of feature amount and the OCR process are performed as processes at the front stage (hereinafter referred to as “pre-processing”) where history information is registered by a data processing server. If the number of jobs is large, the number of data processing servers for performing a large amount of pre-processing needs to be increased. The increase of the number of data processing servers leads to an increase in system cost, which requires an efficient pre-processing.

Japanese Patent Application Laid-Open No. 2007-214611 discusses a system which separates hidden information embedded in an image from the image, associates the hidden information with image information, and stores the hidden information in a log. The hidden information embedded in an original image can disappear because of the storage thereof in the log as image information. The system stores the separated hidden information separately from the image information to reduce the influence of information disappearance. Since the system separately stores the hidden information related to the limitation of search and viewing, the system implements similar access control of image information stored in the log in addition to the access limitation of the original image.

The concept that control information of search and viewing is embedded in an image as hidden information is present in a conventional technique. However, there is not disclosed the concept that information required for performing image search and full-text search is previously embedded in an image. The conventional technique can control the search and viewing of image information stored in the log, but cannot perform search because the hidden information does not include information for search. Therefore, the process for extracting information for search from an image is always required for each job, thus causing a problem that the foregoing pre-processing cannot be made effective.

### SUMMARY OF THE INVENTION

According to an aspect of the present invention, an image forming apparatus includes a reading unit configured to read watermark information including information for search from an electronic document, and a pre-processing unit configured to execute a process for extracting feature amount or text information as information for search from the electronic document if the reading unit does not read the watermark information including information for search, and to skip the process for extracting feature amount or text information if the reading unit reads the watermark information including information for search.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a network configuration diagram of an image history inspection system according to an exemplary embodiment of the present invention.

FIG. 2 illustrates a hardware configuration of a server and a personal computer (PC), which constitute the image history inspection system according to an exemplary embodiment of the present invention.

FIG. 3 illustrates a hardware configuration of an image forming apparatus, which constitutes the image history inspection system according to an exemplary embodiment of the present invention.

FIG. 4 illustrates a configuration of software modules of the image forming apparatus according to an exemplary embodiment of the present invention.

FIG. 5 illustrates a configuration of software modules of a user PC according to an exemplary embodiment of the present invention.

FIG. 6 illustrates a configuration of software modules of a data processing server according to an exemplary embodiment of the present invention.

FIG. 7 is a flow chart illustrating the flow of a log generation process by the image forming apparatus or the user PC according to an exemplary embodiment of the present invention.

FIG. 8 is a flow chart illustrating the flow of a log registration process by the data processing server according to an exemplary embodiment of the present invention.

FIG. 9 illustrates document patterns and process modes in the image history inspection system according to an exemplary embodiment of the present invention.

### DESCRIPTION OF THE EMBODIMENTS

Various exemplary embodiments, features, and aspects of the invention will be described in detail below with reference to the drawings.

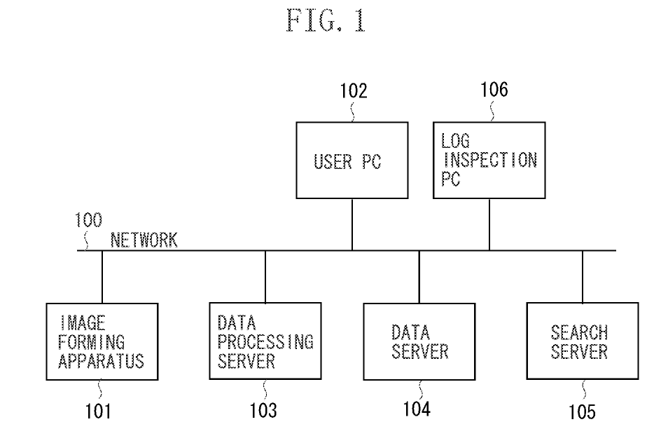

FIG. 1 illustrates a network configuration diagram of an image history inspection system according to a first exemplary embodiment of the present invention.

In the image history inspection system, an image forming apparatus 101, a user personal computer (PC) 102, a data processing server 103, a data server 104, a search server 105, and a log inspection PC 106 are connected to a network 100. The network 100 is a local area network (LAN) used in an office and a wide area network (WAN) extensively used over the Internet. The image history inspection system includes the network, each apparatus, a PC, and server connected to the networks.

In FIG. 1, the image forming apparatus 101 has a network function, a scan function, a printer function, and a file server function. The functions are compositely operated to operate a copying machine and a printer. The image forming apparatus 101 has an agent function to collect a history. The agent function transfers the job history and the content history acquired by the device in relation to jobs such as copy and facsimile which the user performs by means of the image forming apparatus 101 to the data processing server 103.

The job history includes information such as the type of a job executed by a user, the name of the user, date and time, the name of an apparatus generating the job, and others. The content history includes image information or text information input or output along with the execution of the job.

The user PC 102 is a PC which an end user uses on business and also referred to as an information processing apparatus. In general, the user PC 102 can create an electronic document, transmit and receive mail, and access a LAN and the Internet using a web browser. The user PC 102 is provided with a printer driver for causing a predetermined printer to execute printing. The user opens the electronic document with the user PC 102 to enable printing by the predetermined printer.

The printer driver has a function to acquire the job history and the content history during printing. The user PC 102 has a function to transmit history information to the data processing server 103. A print server (not illustrated) may be provided to execute printing from the user PC 102 via the print server. In this case, a function to transmit history information to the data processing server 103 is arranged in the print server.

The data processing server 103 processes data of history information and registers data in the database. The data processing includes the conversion of resolution of image information, the conversion of a format, and the compression of data. The data processing also includes the extraction process of feature amount for image search and the optical character recognition (OCR) process for full-text search. In the image history inspection system, the data processing server 103 also has an object to disperse a connected load from a large number of image forming apparatuses 101 and user PCs 102 and a data registration load to the data server 104. If the number of image forming apparatuses 101 and user PCs 102 is small, a connected load to the data processing server 103 is small, so that the function of the data processing server 103 is caused to stay in the data server 104 to reduce the number of servers.

The data server 104 includes a database and a large capacity storage (not illustrated) and manages the history information in an integrated fashion. The database has one or more data tables with a peculiar table structure, and stores and manages the job history, the content history, the feature amount, text information, and system management information.

The data processing server 103 uses an open database connectivity (ODBC) and other data access providers to register the history information in the data server 104.

The search server 105 provides a function to search the history information managed by the data server 104. The search server 105 has a web server function. An inspector accesses the search server 105 using the web browser of the log inspection PC 106 to enable searching and viewing history. The search function includes a function to search the job history (attribute search), a function to search the content history with an image (image search), and a function to search the content history with a text (full-text search). The search server 105 also can search the history with the search functions compositely combined.

The log inspection PC 106 is a PC which the inspector uses to inspect the history information and is provided with a web browser. The inspector accesses the search server 105 using the web browser and executes the search of the history information. The inspector specifies a key word or an image in relation to confidential information to search the job history, thereby allowing inspecting the job history of the confidential information.

The feature amount is the one that quantitatively represents a feature related to the color of an image, a feature related to a shape (edge information), and a feature related to luminance. When the content history is registered in the data server 104, the data processing server 103 extracts the feature amount from image information using a known algorithm.

The image search is executed by the log inspection PC 106 providing an image desired to be searched as a query image. The query image is uploaded to the search server 105. The search server 105 extracts feature amount from the query image to perform a process for the feature amount registered in the data server 104 and a predetermined calculation. The result of the calculation process is acquired as similarity to the query image. The search server 105 provides the similarity for a search result to create a web page. The inspector refers to the web page through the web browser of the log inspection PC 106.

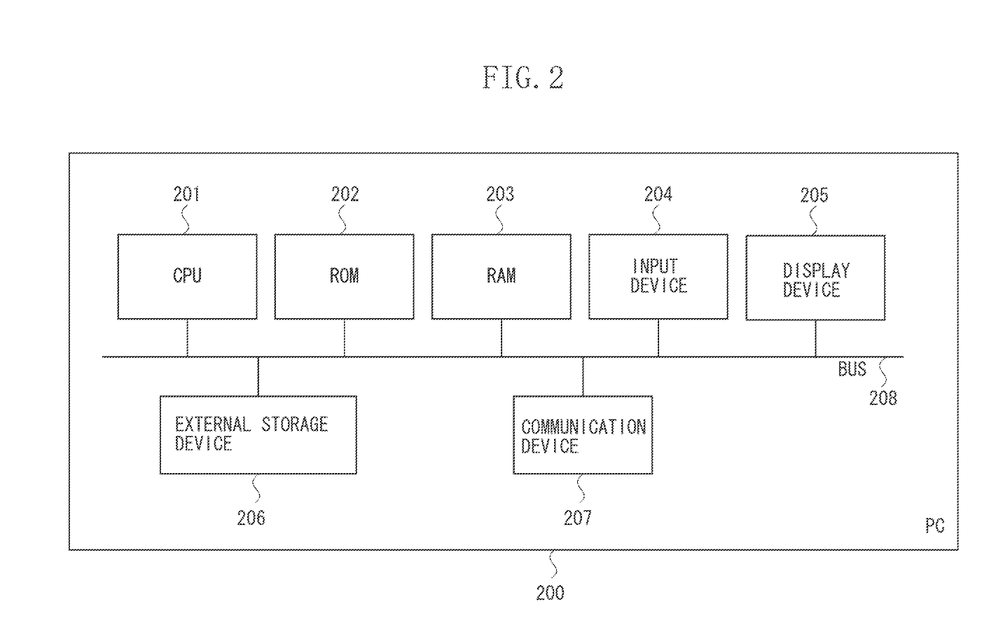

FIG. 2 illustrates a hardware configuration of a server and a PC, which constitute the image history inspection system. In FIG. 2, a central processing unit (CPU) 201 performs various-data processes related to the acquisition of the job history and a calculation process for search and controls components connected to a BUS 208.

A read-only memory (ROM) 202 is a dedicated memory for reading data. The ROM 202 stores a basic control program fora computer 200. A random access memory (RAM) 203 is a memory for reading and writing data. The RAM 203 is used for various-calculation processing of the CPU 201 and temporarily storing data. An external storage device 206 is used as a temporary storage area for a system program of an operating system (OS) of the computer 200, a program of the image history inspection system, and data being processed. The external storage device 206 is slower in the input and output of data than the RAM 203, but can store a larger amount of data than that. A magnetic storage apparatus (hard disk drive (HDD)) mainly corresponds to the external storage device 206. Furthermore, an apparatus in which external media such as a CD-ROM (compact disc ROM), DVD-ROM (digital versatile disc ROM) and a memory card are connected to read and record data is included in the external storage device 206.

An input device 204 inputs characters and data to the computer 200. Various types of key boards and mice correspond to the input device 204. A display device 205 displays process results of the computer 200. A CRT or a liquid crystal monitor corresponds to the display device 205. A communication device 207 is used in a case where a LAN is connected to perform data communication based on TCP/IP (Transmission Control Protocol/Internet Protocol), mutually communicating with other computers.

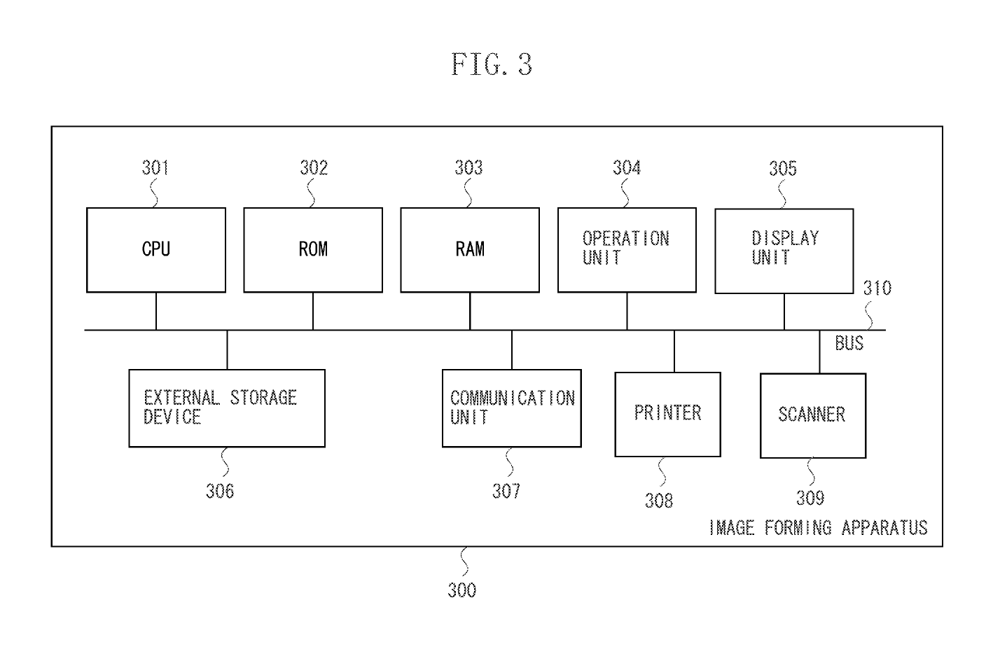

FIG. 3 illustrates a hardware configuration of an image forming apparatus, which constitutes the image history inspection system. In FIG. 3, a CPU 301 performs various data processes related to a job process and calculation for control and controls components connected to a BUS 301.

A ROM 302 is a dedicated memory for reading data. The ROM 302 stores a basic control program for an image forming apparatus 300. A RAM 303 is a memory for reading and writing data. The RAM 303 is used for various-calculation processing of the CPU 301 and temporarily storing data. An external storage device 306 is used as a storage area for a control program of the image forming apparatus 300.

An operation unit 304 includes various buttons for operating the image forming apparatus 300 and the control mechanism therefore. A display unit 305 is formed of a LCD and displays values input from the operation unit 304 and state of the image forming apparatus 300. A communication unit 307 connects a local area network cable and a telephone line to perform network communication and facsimile communication based on TCP/IP.

A printer 308 is a printing unit for converting predetermined PDL (Page Description Language) information into image information and includes a mechanism for printing the image information on a paper medium. A scanner 309 is a scanner unit for scanning the paper medium to acquire image information.

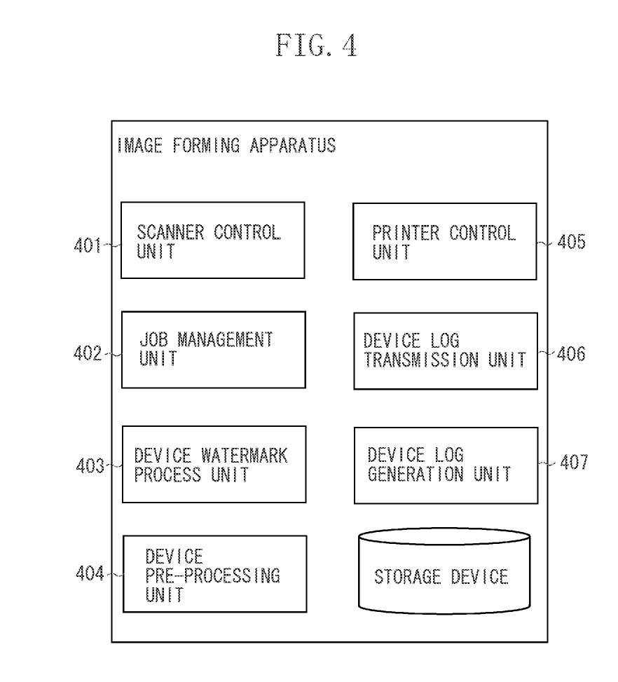

FIG. 4 illustrates a configuration of software modules of the image forming apparatus. In FIG. 4, a scanner control unit 401 is a software module for controlling the scanner 309. A printer control unit 405 is a software module for controlling the printer 308.

A job management unit 402 controls and manages the execution of various jobs such as copy, facsimile, print, scan, and sending. For example, a copy job is a composite process for the scanner 309 acquiring image information from a paper medium and performing predetermined image processing and then the printer 308 printing the image processing on a paper medium. The job management unit 402 generates a copy job and controls and manages such a series of the composite process as the copy job. A device log generation unit 407 generates the job history and the content history accompanying the execution of jobs. For a scan job, for example, the device log generation unit 407 generates attribute information relevant to the scan job as the job history and generates the image information read by the scanner 309 as the content history. The scan job being a job type is designated as the job history. Furthermore, a user name, a job execution date, a job execution device name, and a document name are recorded therein.

A device log transmission unit 406 transmits the job history and the content history to the data processing server 103 via the network 100 and performs control for registering the history in the database. The device log transmission unit 406 also performs transmission control of history information, retrial control for the case of communication error, and a process for acquiring various setting information from the database.

A device watermark process unit 403 controls a process for reading watermark information embedded in a paper document and a process for embedding watermark information when image information is printed on the paper medium. A watermark technique used in the image history inspection system is used for superposing information on an image irrespective of visibility or invisibility. Watermark information in the image history inspection system includes information used for executing search. The feature amount for searching an image and the result of OCR for full-text search, i.e., text information, are included therein. The process concerning the reading and embedding of the watermark information is performed by a known technique.

A device pre-processing unit 404 executes a process for extracting the feature amount from an image and a process for acquiring text information by an OCR. The image forming apparatus associates the feature amount and text information with the job history and content history, transmits the feature amount and text information to the data processing server 103, and registers the feature amount and text information therein. This is made before the history information is registered, therefore, being referred to as pre-processing.

The device pre-processing unit 404 includes a mechanism for determining whether the read watermark information is information used for search. As a result of determination, if information used for search can be read, the device pre-processing unit 404 skips the process for extracting the feature amount and the OCR process. If information used for search cannot be read, the device pre-processing unit 404 executes the processes.

The device pre-processing unit 404 uses a flag for determining whether information embedded as the watermark information is information used for search. The flag meaning that the information for search and the embedded information are information used for search is added to the watermark information embedded in an image. That is why the device pre-processing unit 404 can determine whether the watermark information read by determining the flag is information used for search.

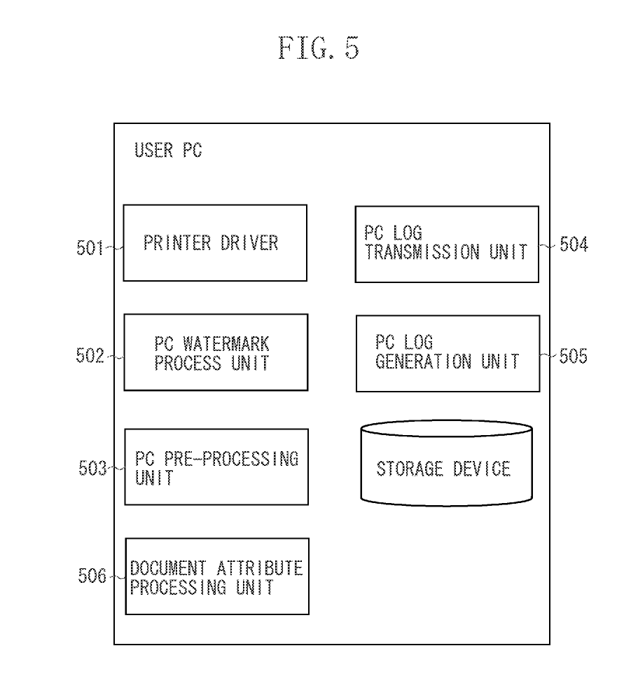

FIG. 5 illustrates a configuration of software modules of the user PC. In FIG. 5, a printer driver 501 generates print data for a printer from an electronic document according to instructions of an application. The print data generated by the user PC are transmitted to the printer via the network 100 according to instructions of the printer driver 501 (electronic document transmission). The print data generated by the user PC may be printed by the printer 308 of the image forming apparatus 101, for example.

A PC log generation unit 505 generates the job history and the content history accompanying the print job. Because of the print job in the user PC, a user name which can be identified by login authentication to the user PC is allocated as the user name designated in the job history. As for a job execution device name, a computer name of the user PC is designated. Furthermore, IP address and MAC address of the user PC and a domain name are also designated in the job history.

The generated history information is transmitted to the data processing server 103 by a PC log transmission unit 504 and is registered therein.

A PC watermark process unit 502 controls a process for reading watermark information superposed on image information retained as an electronic file and a process for embedding watermark information when image information is printed on a paper medium.

The PC watermark process unit 502 further controls a process for reading attribute information provided for a document generated as an electronic file. The image history inspection system according to the present exemplary embodiment is capable of reading information for search retained in the attribute information provided for the document.

A PC pre-processing unit 503 has a function similar to that of the device pre-processing unit 404. If information for search does not exist in a document attribute when printing is executed, the PC pre-processing unit 503 executes the extraction process of the feature amount and the OCR process to generate the information for search. The PC watermark process unit 502 executes a process for embedding the information for search in an image. The printer driver 501 generates print data of an image in which watermark information is embedded.

A print process is executed in the process of application software whereby the electronic document is edited and viewed. For this reason, the PC log generation unit 505, the PC watermark process unit 502, and the PC pre-processing unit 503 operate in the software process in which printing is executed in timing in which the printer driver 501 operates. The transmission process of the history information may be executed in timing different from that of the print process. For this reason, the PC log transmission unit 504 operates as a process different from the software process for executing printing.

A document attribute processing unit 506 provides a document with information for search being the feature amount and the text information extracted by the PC pre-processing unit 503 as attribute information. Although the document attribute processing unit 506 operates in collaboration with the application software whereby the document is edited and viewed, the document attribute processing unit 506 may operate as an independent application. Information related to search is previously provided for the electronic document to allow reducing a load in printing.

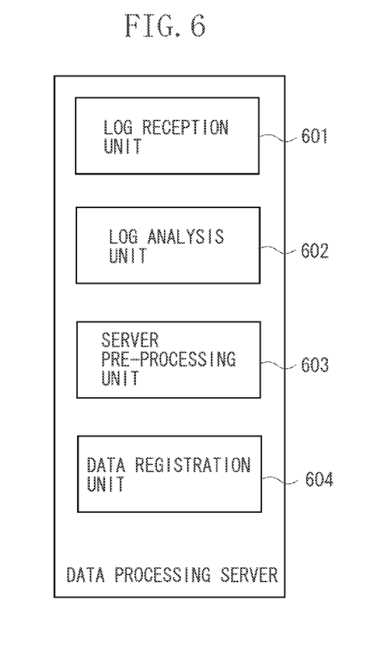

FIG. 6 illustrates a configuration of software modules of the data processing server 103. In FIG. 6, a log reception unit 601 receives the history information and information for search transmitted from either or both of the device log transmission unit 406 and the PC log transmission unit 504. Design is performed on the assumption that data is transmitted by the web service to allow communication over a fire wall or a router. In the present exemplary embodiment, description is made on the assumption that a simple object access protocol (SOAP) is used. The job history and the content history are generated in units of job in the device log generation unit 407 or the PC log generation unit 505. This is because the job history and the content history are information generated along with the execution of the job. The information is transmitted in units of job. The device log transmission unit 406 and the PC log transmission unit 504 control the transmission and reception of information in units of job. After the transmission and reception of information are finished, the device log transmission unit 406 and the PC log transmission unit 504 delete information from the storage region of the image forming apparatus 101 and the user PC 102. The received information is temporarily stored in the external storage device 206 of the data processing server 103.

The data structure of the job history, the content history, and information for search are extendible to adapt to the future expansion of the system. The information for search can include not only the feature amount and the text information, but also search index information acquired from the text information. The text information, however, can be transmitted as the content information. Therefore, if the text information is transmitted as the content information, it is controlled not to include the text information in information for search.

A log analysis unit 602 analyzes received information. The log analysis unit 602 analyzes whether information for search as well as the job history and the content history is included to determine whether to skip the process step of a server pre-processing unit 603.

The server pre-processing unit 603 includes a process for extracting the feature amount from the image information and a process for extracting text information by the OCR. The feature amount is used for searching for an image. The text information plays the role of enabling character information included in image information to be identified by a computer. The text information is also used in the full-text search. The content history temporarily stored in the data processing server 103 is subjected to the process of the server pre-processing unit 603 in units of job.

A data registration unit 604 registers the job history, the content history, and information for search in the database managed by the data server 104. The registration process to the database is configured so that an ODBC or a database access provider inherent in a database can be used.

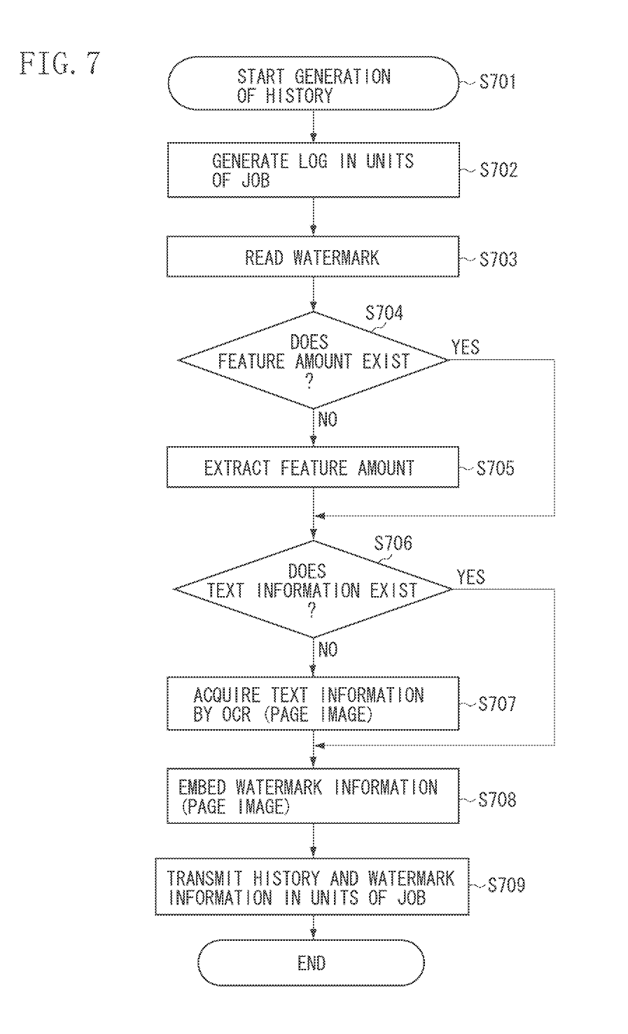

FIG. 7 is a flow chart illustrating the flow of a log generation process on the image forming apparatus 101 or the user PC 102. The user places a document on the image forming apparatus 101 and causes the image forming apparatus 101 to execute jobs such as copy, scan, and the like through an operation panel. Alternatively, the user causes the user PC 102 to execute printing by application software such as document preparation software. In step S701, a log generation flow in FIG. 7 is started along with the execution of the jobs. The execution of the jobs is managed and controlled by the job management unit 402 or the printer driver 501. For jobs accompanied with the reading of a document, the scanner control unit 401 scans a document to acquire image information under the control of the job management unit 402. The image information is stored in a storage device and provided for the output result of the jobs.

The processes of the job execution and the log generation may be synchronized with each other from the viewpoint of both job process performance and securement of security by acquiring a log or may be executed by the judgment of the user in another process in different timing.

In step S702, the device log generation unit 407 or the PC log generation unit 505 generates a log in units of job. The log refers to the job history and the content history. The device log generation unit 407 generates the job history from the job management unit 402 and stores the job history in the storage device. The content history is stored with the acquired image information associated with the job history. The device log generation unit 407 or the PC log generation unit 505 generates a job image ID for uniquely identifying a job image to associate the content history with the job history and allocate the job image ID to the file name of the image information. Furthermore, the device log generation unit 407 or the PC log generation unit 505 causes a part of the job history to retain the job image ID.

In step S703, the device watermark process unit 403 or the PC watermark process unit 502 reads watermark information from the image information. Watermark information is embedded with a document image for a background such that fine dot patterns are superposed thereon. The device watermark process unit 403 or the PC watermark process unit 502 identifies the feature of the dot pattern and restores the embedded information. The watermark information includes at least feature amount and text information. A restoring process performs a process for reading the information.

The PC watermark process unit 502 has also a function to read the attribute information of a document, so that the PC watermark process unit 502 performs the reading of document attribute as well as the determination of watermark information. In this case, the feature amount and text information are retained in the document attribute. In step S703, it can be determined whether the feature amount or text information exists. In step S704, the device pre-processing unit 404 or the PC pre-processing unit 503 determines whether the feature amount can be read. If the feature amount exists (YES in step S704), the device pre-processing unit 404 or the PC pre-processing unit 503 skips a process for extracting the feature amount (step S705). In step S706 where to determine whether text information exists, the device pre-processing unit 404 or the PC pre-processing unit 503 determines whether the text information can be read. If the text information exists (YES in step S706), the device pre-processing unit 404 or the PC pre-processing unit 503 skips a process for extracting the text information (step S707). The device watermark process unit 403 or the PC watermark process unit 502 executes a watermark embedding process in step S708.

If the feature amount does not exist (NO in step S704), the device pre-processing unit 404 or the PC pre-processing unit 503 proceeds to step S705. In step S705, a numeral value for identifying the feature of the image is extracted. Step S705 is executed by the device pre-processing unit 404 or the PC pre-processing unit 503. Step S705 is executed for each image area in a page image. In step S705, if there are two image areas on page 1 and five image areas on page 2 in a two-page document, for example, the extraction process is executed twice on page 1 and five times on page 2. The extracted feature amount is associated with the content history and is stored.

If the text information does not exist (NO in step S706), the device pre-processing unit 404 or the PC pre-processing unit 503 proceeds to step S707. In step S707, text information is acquired from the image information by a known OCR technique. Step S707 is executed by the device pre-processing unit 404 or the PC pre-processing unit 503.

Only either the feature amount or the text information may be embedded as watermark information. For this reason, steps S705 and S707 can be separately executed. Since these processes are separated from each other, step S707 may precede step S705.

In step 708, watermark information is embedded in an image to be output. Step S708 is executed by the device watermark process unit 403 or the PC watermark process unit 502. Images output by the image forming apparatus 101 includes an image which is recorded and output to a paper medium by copy or print, for example. Furthermore, images output by the image forming apparatus 101 include an image which is attached to mail and transmitted or received by facsimile, for example.

When an image is output to a paper medium, information for search is superposed on the image as watermark information, printed and output. The information for search is generated by the device pre-processing unit 404 or the PC pre-processing unit 503 or read from watermark information of the previously input image information.

In step S709, the job history, the content history, and the information for search are transmitted to the data processing server 103. Step S709 is executed by the device log transmission unit 406 or the PC log transmission unit 504.

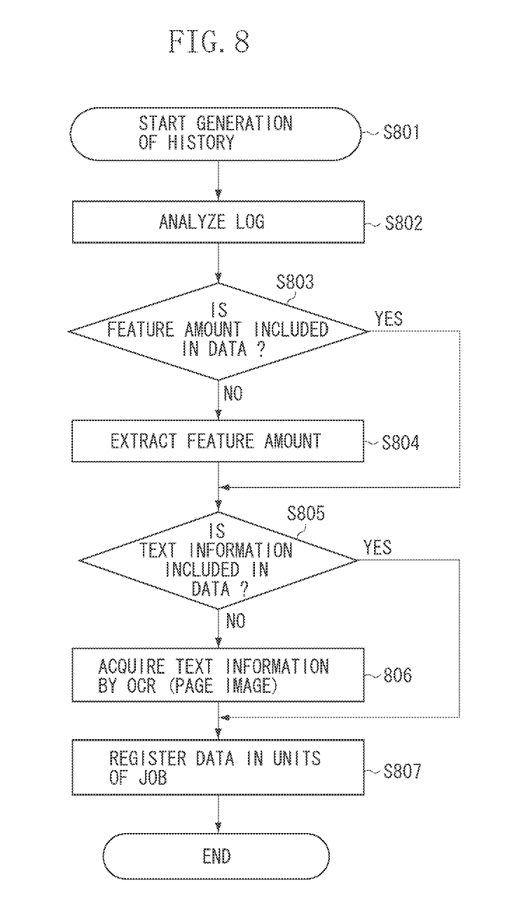

The information transmitted in step S709 is received by the log reception unit 601 of the data processing server 103. FIG. 8 is a flow chart illustrating the flow of a log registration process in the data processing server 103. In step S801, history and watermark information are generated in units of job, so that the log registration process illustrated in FIG. 8 is performed also in units of job. The reception process of history and watermark information in the log reception unit 601 and the registration process illustrated in FIG. 8 can be performed in parallel. The parallel process is more efficient.

In step S802, the log analysis unit 602 confirms whether watermark information is included in the received data. The log analysis unit 602 determines whether information for search is included in the received history and watermark information. The information received by the log reception unit 601 is communicated in a format defined according to XML. For this reason, the log analysis unit 602 can identify the type of the received data by recognizing the data format.

The information for search is the feature amount and the text information which are separately identified by the log analysis unit 602. In step S803, the server pre-processing unit 603 identifies whether the feature amount is included in the received data based on the result of analysis by the log analysis unit 602. If the feature amount is included (YES in step S803), the server pre-processing unit 603 skips step S804. If the feature amount is not included (NO in step S803), the server pre-processing unit 603 proceeds to step S804, in which the feature amount is extracted from the received history information.

In step S804, the server pre-processing unit 603 extracts a numerical value for identifying the feature of an image. The server pre-processing unit 603 associates the extracted feature amount with the job history and the content history and stores the feature amount.

In step S805, the server pre-processing unit 603 identifies whether the text information is included in the received data based on the format of the received data. If the text information is included (YES in step S805), the log analysis unit 602 skips step S806. If the text information is not included (NO in step S805), the processing proceeds to step S806. In step S806, the server pre-processing unit 603 acquires text information from the image information included in a log by a known OCR technique.

In step S807, the data registration unit 604 registers the feature amount and the text information as the received job history, content history, and information for search in the database managed by the data server 104. When the registration is completed, the process of log information for a job is finished and the registration process for the following job data proceeds.

In the image history inspection system, the process of the server pre-processing unit 603 of the data processing server 103 is always skipped. This is because information for search is previously acquired in the image forming apparatus 101 or the user PC 102. Therefore, both steps S804 and S806 which are conventionally performed each time history information is registered are skipped. This substantially reduces a processing load of the data processing server 103.

The reason the data processing server 103 includes the server pre-processing unit 603 is that the data processing server 103 may receive the job history and the content history from devices other than image forming apparatus 101 or the user PC 102.

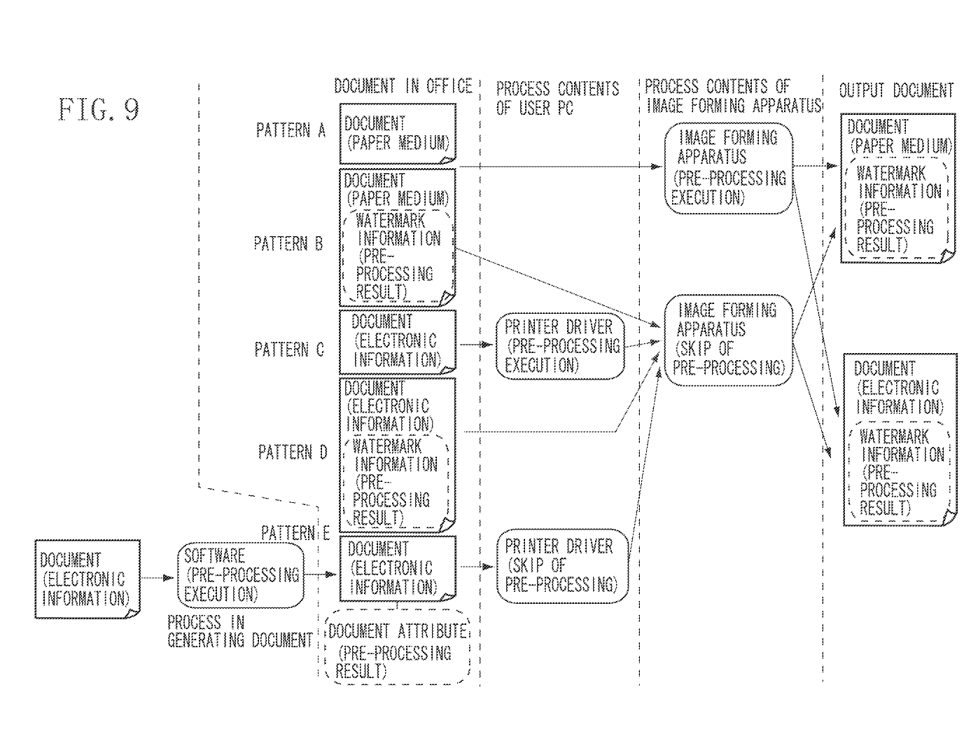

FIG. 9 illustrates document patterns and process modes in the image history inspection system. In FIG. 9, a pattern A shows a document which is made of a paper medium and for which watermark information is not provided. When copy and scan are performed by the image forming apparatus 101, step S705 is executed because of non-existence of information for search. A pattern B shows a document which is made of a paper medium and for which watermark information is provided. When copy and scan are performed by the image forming apparatus 101 according to the present exemplary embodiment, a series of pre-processing steps is skipped because of existence of information for search. The image forming apparatus 101 and the user PC 102 are arranged to gradually circulate the document in the pattern B in the office. This further reduces a processing load of the data processing server 103.

A pattern C shows a document which is electronic information and for which watermark information is not provided. A process related to printing is executed by the printer driver 501 of the user PC 102. Step S705 is executed because of non-existence of watermark information. Since information for search is already extracted by the user PC 102, the device pre-processing in steps S705 and S707 in the image forming apparatus 101 is skipped.

A pattern D shows a document which is electronic information and image information on which watermark information is superposed. For example, the pattern D corresponds to a case where the image forming apparatus 101 stores a facsimile reception image or image information received by an e-mail transmission function as electronic information without printing them on a paper medium. In the document in the pattern D, since information for search can be acquired, both of steps S705 and S707 in the device pre-processing unit 404 are skipped.

A pattern E shows a document which is electronic information and information for search is stored as document attribute instead of watermark information. For example, the pattern E corresponds to a case where document creation software acquires the feature amount and the text information and stores them as document attribute and a dedicated application acquires the feature amount and the text information from document information and stores them as document attribute. In the pattern E, information for search is attached to the document, both of steps S705 and S707 in the PC pre-processing unit 503 are skipped.

More specifically, if watermark information including information for search is neither read and attribute information including information for search is nor attached to an electronic document, the PC pre-processing unit 503 executes the processes in steps S705 and S707 as information for search. If watermark information including information for search is read, the PC watermark process unit 502 embeds the watermark information in the electronic document. If watermark information including information for search is neither read and attribute information including information for search is nor attached to the electronic document, the PC watermark process unit 502 embeds the watermark information including information for search extracted by the PC pre-processing unit 503 in the electronic document.

On the other hand, the image forming apparatus 101 further includes a function to acquire attribute information from an electronic document (attribute information acquisition). If watermark information including information for search is neither read in the device watermark process unit 403 and attribute information including information for search is nor acquired, the device pre-processing unit 404 executes the processes in steps S705 and S707. If watermark information including information for search is read in the device watermark process unit 403 and attribute information including information for search is acquired, the device pre-processing unit 404 skips the processes in steps S705 and S707.

As the pattern E shows, the introduction of the application capable of storing information for search as the document attribute gradually converges electronic documents circulating in an office into the patterns D or E. As for documents handled as a paper medium, on the other hand, the circulation of the pattern B increasingly reduces a processing load of the data processing server 103.

The exemplary embodiments of the present invention are described with reference to the specific examples heretofore. It is to be understood that the present invention is not limited to the embodiments. The present invention can also be realized by executing the following process. More specifically, the process may be performed such that software (program) realizing the functions of the forgoing exemplary embodiments is supplied to a system or an apparatus via a network or various types of storage media and the computer (or a CPU, a micro-processing unit (MPU), and/or the like) of the system or the apparatus reads and executes the program. In this case, the program and the storage media storing the program constitute the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-298808 filed Dec. 28, 2009, which is hereby incorporated by reference herein in its entirety.

What is claimed is:

1. An image forming apparatus comprising:
a reading unit configured to read watermark information including information for search from an electronic document; and
a pre-processing unit configured to execute a process for extracting feature amount or text information as information for search from the electronic document if the reading unit does not read the watermark information including information for search, and to skip the process for extracting feature amount or text information if the reading unit reads the watermark information including information for search.

2. The image forming apparatus according to claim 1, further comprising:
a log generation unit configured to generate a log including image information of an electronic document; and
a transmission unit configured to transmit, if the reading unit reads the watermark information including information for search, the log to a data processing server with the watermark information included in the log generated by the log generation unit, and to transmit, if the reading unit does not read the watermark information including information for search, the log to the data processing server with watermark information including information for search extracted by the pre-processing unit included in the log generated by the log generation unit.

3. The image forming apparatus according to claim 1, further comprising an embedding unit configured to embed, if the reading unit reads the watermark information including information for search, the watermark information in the electronic document, and to embed, if the reading unit does not read the watermark information including information for search, watermark information including information for search extracted by the pre-processing unit in the electronic document.

4. The image forming apparatus according to claim 2, further comprising:
a reading unit configured to read and convert a paper medium document into an electronic document; and
an acquisition unit configured to acquire an electronic document from an information processing apparatus,
wherein, if the reading unit converts the paper medium document into the electronic document, the log generation unit generates a log including image information of the electronic document and, if the acquisition unit acquires the electronic document from the information processing apparatus, the log generation unit generates a log including image information of the electronic document, and
wherein, if the reading unit converts the paper medium document into the electronic document, the reading unit reads watermark information including information for search from the electronic document and, if the acquisition unit acquires the electronic document from the information processing apparatus, the reading unit reads watermark information including information for search from the electronic document.

5. The image forming apparatus according to claim 1, further comprising an attribute information acquisition unit configured to acquire attribute information from an electronic document,
wherein the pre-processing unit executes a process for extracting feature amount or text information as information for search from the electronic document if the reading unit does not read the watermark information including information for search and the attribute information acquisition unit does not acquire attribute information including information for search, and the pre-processing unit skips the process for extracting feature amount or text information from the electronic document if the reading unit reads the watermark information including information for search and the attribute information acquisition unit acquires attribute information including information for search.

6. An information processing apparatus comprising:
a reading unit configured to read watermark information including information for search from an electronic document; and
a pre-processing unit configured to execute a process for extracting feature amount or text information as information for search from the electronic document if the reading unit does not read the watermark information including information for search, and to skip the process for extracting feature amount or text information from the electronic document if the reading unit reads the watermark information including information for search.

7. The information processing apparatus according to claim 6, further comprising:
a log generation unit configured to execute a job related to an electronic document and to generate a log including image information of the electronic document; and
a transmission unit configured to transmit, if the reading unit reads the watermark information including information for search, the log to a data processing server with the watermark information included in the log generated by the log generation unit, and to transmit, if the reading unit does not read the watermark information including information for search, the log to the data processing server with watermark information including information for search extracted by the pre-processing unit included in the log generated by the log generation unit.

8. The information processing apparatus according to claim 6, further comprising an embedding unit configured to embed, if the reading unit reads the watermark information including information for search, the watermark information in the electronic document, and to embed, if the reading unit does not read the watermark information including information for search, watermark information including information for search extracted by the pre-processing unit in the electronic document.

9. The information processing apparatus according to claim 8, further comprising an electronic document transmission unit configured to transmit the electronic document in which the watermark information including information for search is embedded by the embedding unit to an image forming apparatus.

10. The information processing apparatus according to claim 9, wherein the pre-processing unit extracts feature amount or text information as information for search from the electronic document if the reading unit does not read the watermark information including information for search and attribute information including information for search is not added to the electronic document,
wherein the embedding unit embeds, if the reading unit reads the watermark information including information for search, the watermark information in the electronic document, and embeds, if the reading unit does not read the watermark information including information for search and attribute information including information for search is not added to the electronic document, watermark information including information for search extracted by the pre-processing unit in the electronic document, and
wherein the electronic document transmission unit transmits the electronic document in which the watermark information including information for search is embedded by the embedding unit and to which the attribute information including information for search is added to the image forming apparatus.

11. A data processing server comprising:
a log reception unit configured to receive a log including image information of an electronic document from either or both of an image forming apparatus and an information processing apparatus; and
a pre-processing unit configured to execute a process for extracting feature amount or text information as information for search from the image information if watermark information is not included in the log received by the log reception unit, and to skip the process for extracting feature amount or text information from the image information if watermark information is included in the log received by the log reception unit.

12. An information processing method executed by an image forming apparatus, the information processing method comprising:
reading watermark information including information for search from an electronic document; and
executing a process for extracting feature amount or text information as information for search from the electronic document if the watermark information including information for search is not read, and skipping the process for extracting feature amount or text information from the electronic document if the watermark information including information for search is read.

13. An information processing method executed by an information processing apparatus, the information processing method comprising:
reading watermark information including information for search from an electronic document; and
executing a process for extracting feature amount or text information as information for search from the electronic document if the watermark information including information for search is not read, and skipping the process for extracting feature amount or text information from the electronic document if the watermark information including information for search is read.

14. An information processing method executed by a data processing server, the information processing method comprising:
receiving a log including image information of an electronic document from either or both of an image forming apparatus and an information processing apparatus; and
executing a process for extracting feature amount or text information as information for search from the image information if watermark information is not included in the received log, and skipping the process for extracting feature amount or text information from the image information if watermark information is included in the received log.

15. A computer-readable storage medium storing a program for causing a computer to function as:
a reading unit configured to read watermark information including information for search from an electronic document; and
a pre-processing unit configured to execute a process for extracting feature amount or text information as information for search from the electronic document if the reading unit does not read the watermark information including information for search, and to skip the process for extracting feature amount or text information if the reading unit reads the watermark information including information for search.

16. A computer-readable storage medium storing a program for causing a computer to function as:
a log reception unit configured to receive a log including image information of an electronic document from either or both of an image forming apparatus and an information processing apparatus; and
a pre-processing unit configured to execute a process for extracting feature amount or text information as information for search from the image information if watermark information is not included in the log received by the log reception unit, and to skip the process for extracting feature amount or text information from the image information if watermark information is included in the log received by the log reception unit.
